(19) United States
(12) Patent Application Publication
(10) Pub. No.: US 2016/0191485 A1
(43) Pub. Date: Jun. 30, 2016

(54) SYSTEMS AND METHODS FOR SITE DATA COLLECTION

(71) Applicants: Karthikeyan Rajangam, Tracy, CA (US); Subramanian Meiyappan, San Jose, CA (US); Anil Kumar Kavipurapu, San Francisco, CA (US)

(72) Inventors: Karthikeyan Rajangam, Tracy, CA (US); Subramanian Meiyappan, San Jose, CA (US); Anil Kumar Kavipurapu, San Francisco, CA (US)

(21) Appl. No.: 14/941,450

(22) Filed: Nov. 13, 2015

Related U.S. Application Data
(60) Provisional application No. 62/079,456, filed on Nov. 13, 2014.

(51) Int. Cl. H04L 29/06; G06F 17/30; H04L 29/08

(52) U.S. Cl. CPC H04L 63/08; H04L 67/1095; G06F 17/30174

(57) ABSTRACT

A system and method for collecting, storing, maintaining and presenting data to optimize and make more efficient the installation of a communication system. A mobile device running a field application, a remote server running a server side application and data storage are employed in the system. A subset of these systems can be used in some use cases. The disclosed system may display, generate reports and download the collected data to facilitate installation of the communications system. The system may also provide an API to retrieve the collected data.

This U.S. non provisional patent application claims the benefit of priority to pending U.S. provisional patent application entitled, “SYSTEMS AND METHODS FOR SITE DATA COLLECTION”, to Rajangam, et al., Ser. No. 62/079,456, filed Nov. 13, 2014 and is hereby incorporated by reference in its entirety.

### FIELD

This disclosure relates generally to collecting, storing, maintaining and presenting data during the installation of a system. More specifically, but not exclusively, the disclosure relates to systems, methods, and computer program products for collecting data, processing the data, storing the data, maintaining the integrity of the data, presenting and exchanging the data during the various phases of installation of a system at a facility.

### BACKGROUND

When a system needs to be installed at a facility there are several steps that need to be taken to ensure that a process is adhered to and that information about the install be available for future reference. When we refer to “system” it means that there are one or more pieces of equipment involved along with wiring, cabling, commissioning and inspection. For example, installation of a cellular base station at a tower is a cumbersome and elaborate process that usually spans several months. Any errors or omissions in data collection can cause severe cost and time impact to the revenue that would otherwise be generated by that base station. In some cases, incorrect data could affect the service delivered by the base station leading to unhappy customers and loss of revenue. Usually, the collected data is validated only after the data has been verified at a remote site away from the actual system installation site.

Most of the system installation data, today, is manually collected in the form of paper and pencil and converted to electronic form when convenient to do so. Even for extremely complex systems such as cellular base station installs, field technicians and installers uses the paper and pencil method to record data at the site when the system is installed. For a cellular install, there are various phases such as A&E walk, construction, installation, punch-walk and commissioning. In each of these phases one ore more forms are to be filled to record the progress of the installation. In most cases, this data is collected today, using a pencil and paper method at the site. Only when they have access to a computer, they enter this data into an electronic form and store it electronically for reference and for use with other applications that may need this data. This method is every error prone, delay prone and necessitates repeated visits to system installation sites proving to be costly, time consuming, and ineffective.

Accordingly, there is a need for improved data collection systems to address these and other problems with existing systems and methods employed for data collection. There have been several advances in mobile handheld technology such as smartphones and tablets that can be effectively employed for such data collection at the site during the time of the system install.

Most RF/cellular system installations require that various components of the installed system such as RF cables, Antennas etc be “swept” to analyze their characteristics to provide reliable service by the system. They are “swept” for impedance characteristics such as line-loss, distance to fault, return loss (VSWR), Passive Intermodulation (PIM) etc. Fiber optic cables used in these installations use instruments like Optical Time Domain Reflectometer (OTDR), Video Inspection Probe (VIP) etc, Modern cellular base station installs typically require 200+ “sweeps” or “measurements”. The measurement takes more than 2 days; the analysis of this data to extract salient features and report generation takes another 2 days.

Installation for Distributed Antenna Systems (DAS) in a facility such as a mall or a stadium requires on the order of 1000+ sweeps of both RF coax and fiber optic cables.

Incorrect setups necessitate site visits and re-measurement of this data. This invention eases the sweep measurements by using a personal computing device, such as a tablet PC or a Smartphone, to setup and perform the measurements on the aforementioned instruments or any other instruments. The collected data is then uploaded to the server-side application for further analyses, presentation of the data.

### SUMMARY

In accordance with the present disclosure, systems, methods and computer program products comprising a computer usable medium having a computer readable program code embodied therein that is adapted to be executed to implement a method for providing effective means of data collection during a system installation.

Various additional aspects, features, and functions are described below in conjunction with the appended Drawings.

### BRIEF DESCRIPTION OF THE DRAWINGS

The present application may be more fully appreciated in connection with the following detailed description taken in conjunction with the accompanying drawings.

FIG. 1 depicts a diagram illustrating details of a the system architecture that is used for data collection, processing, storing, maintaining, presenting and exchanging the data;

FIG. 2 illustrates a diagram illustrating certain details of one aspect where the data is synchronized between the mobile application and a remote server;

FIG. 3 depicts a diagram illustrating details of the framework generator that generates the components needed to establish an end to end service.

FIG. 4 depicts a diagram illustrating details of the framework that does sweep measurement.

FIG. 5 depicts a diagram illustrating details of the framework that does sweep measurement using a custom electronic device controlled by a tablet computer.

### DETAILED DESCRIPTION

Various aspects of the disclosure are described below. It should be apparent that the teachings herein may be embodied in a wide variety of forms and that any specific structure, function, or both, being disclosed herein is merely representative. Based on the teachings herein one skilled in the art should appreciate that any aspect disclosed may be implemented independently of any other aspects and that two or more of these aspects may be combined in various ways. For example, a system may be implemented or a method may be practiced using any number of the aspects set forth herein.

As used herein, the term “exemplary” means serving as an example, instance or illustration. Any aspect and/or embodiment described herein as “exemplary” is not necessarily to be construed as preferred or advantageous over other aspects and/or embodiments.

### OVERVIEW

This disclosure relates generally to data collection during a system install using modern handheld devices such as smartphones and tablet computers. In today's wireless world, there are several wired and wireless transceivers being deployed on towers, masts, roof tops, homes, office buildings, electric poles, telephone poles etc. The information that describes the installation is collected and recorded by various personnel at different times during the construction, installation and commissioning of these systems. Some of these installations take several days to weeks. The record keeping for the data for these tasks, more often than not, is entered manually by construction personnel into a paper form which is then entered into a CMS (Configuration Management System) or an EMS (Element Management System, Network Management System)/OSS (Operational Support System) system manually. There are a multitude of instruments used to collect such data. This entire process is error prone and results in multiple site visits which are expensive. This invention attempts to solve this by integrating most of this functionality into user equipment that is carried by the personnel and by collecting most of this data electronically and transferring the data electronically directly to the consumers of this data.

### SYSTEM DESCRIPTION

The system consists of a tablet computer or a smart phone or a laptop that the user carries with connectivity to the internet (such as cellular, wifi) either online all the time, or online on an on-demand basis, and has a wide variety of sensors such as accelerometers, gyroscopes, compasses, pressure sensors, a Personal Area Network (PAN) connectivity interface such as Bluetooth, a USB interface, integrated front and rear-facing cameras, integrated microphones and speakers, handwriting recognition devices and software, voice recognition devices and software, expandable storage mechanisms (SD-card, for example), and integrated location sensors such as GPS. In addition, the system is capable of communicating with a wide variety of instruments such as spectrum analyzers, network analyzers, oscilloscopes, GPS devices etc, by means of a wired or wireless interface between the equipment and the device. In addition, the system has interfaces to peripheral devices such as Google Glass, Watches over the PAN link.

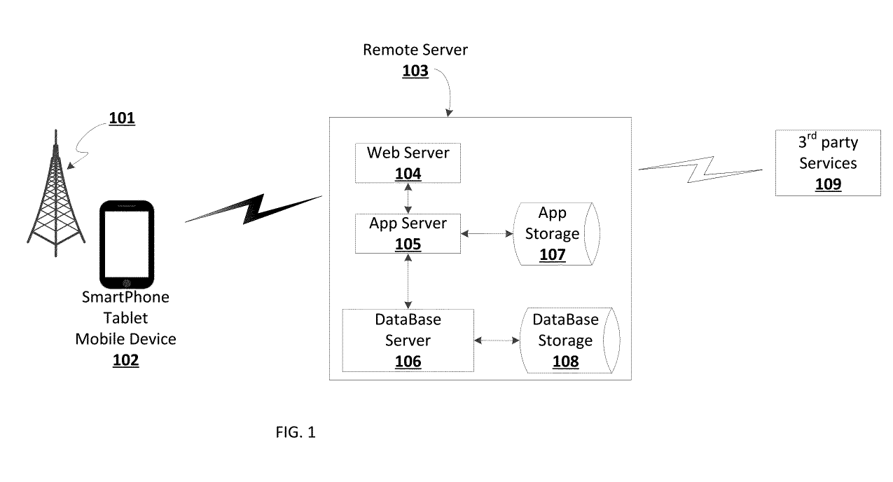

The end to end system consists of a field application, server side application and data storage and is illustrated in FIG. 1. The field application is deployed on a mobile device 102 to collect data with local storage for uploading to a server 103. The mobile device 102 is used to collect data during the construction, install, commissioning and maintenance that may happen on a system-site, such as cell tower 101, for example. A remote storage mechanism is used to store and retrieve all of the collected data for data exchange and presentation of the collected data via a web interface. The data collected from the mobile device 102 is stored locally and may also be synchronized with a remote storage mechanism 108 on a remote server 103. The remote server 103 may consists of a composite set of servers —webserver 104, Application server 105 and Database server 106. The web server 104 provides a web interface between the mobile application and the remote server 103. The application server 105 hosts a set of applications that may process the data that was collected. A multitude of applications may be stored on an Application storage unit 107 and is invoked by the application server 105 either on an as needed basis or pre-loaded into the application server memory. The database server 106 is used to store data into the database storage unit 108. This data may be collected from the mobile application or entered via the web/application services from 104 and 105. A set of APIs and services are available to customers and 3rd party service developers 109 to integrate the data from the service. The system shall support existing cloud services and storage services from any vendor (Amazon, Dropbox, Google etc). Note that each of these entities such as field application and server-side applications and data storage applications can be used as independent entities (for example, one user may desire to just use the field application alone without any of the other services). An overview block diagram of the end to end system is shown in FIG. 1.

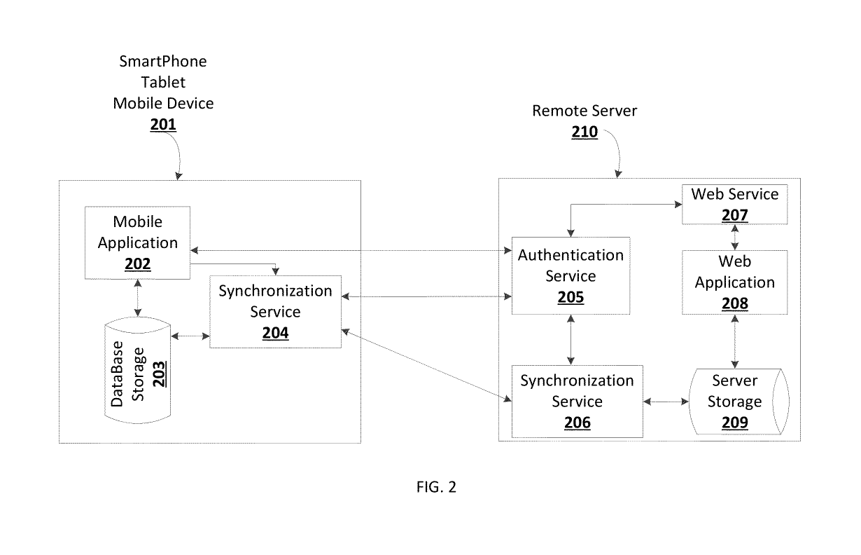

The end to end system also consists of many services as described in FIG. 2. The field mobile device 201 contains the application, data storage 203 and a synchronization service 204 between data on the mobile device and the data on the server. The field application collects the data and stores in local storage 203. The mobile device synchronization service synchronizes the data between remote server 210 and local storage 203. The server side 210 contains an authentication service 205 to allow only authorized service, device, and users to access the server side services and applications. The synchronization service 206 on the server side communicates with the field application synchronization service 204 to keep the data identical between the mobile device 201 and the remote server 210. The synchronization is automatically executed as a background task on both the mobile device and the remote server on an automatic or user decided schedule. The synchronization can also be manually initiated by a user on both the mobile device and the remote server. The web application 208 is used by user to display, generate reports and download the collected data. A set of web service 207 APIs are provided for use by third party application services.

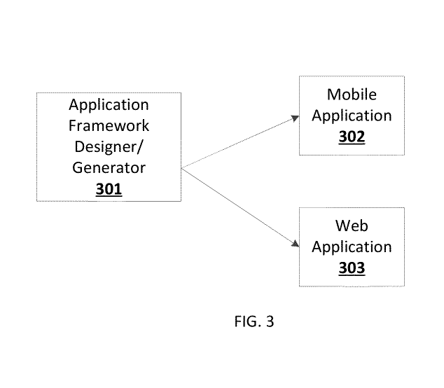

The system allows the application to be customized on a per vendor per product basis. The application is customized from a library of widgets (the widgets have contexts for the field application, server side application and data storage components). The customized field application is designed to guide the personnel to perform various tasks and validate them in-situ in the field or an on-demand basis. A block diagram of the framework that generates the various components is shown in FIG. 3. The application framework designer/generator 301 is provided a set of parameters to generate a custom mobile application 302 and a peer web application 303. There may be some manual tweaks to the generated code bases for final use.

### SERVER SIDE APPLICATION

The server side application consists of the following components—storage server, web server, data base server and application server. The entire suite may be run on a single node or can be run on distributed nodes. It can be run as a local service, a cloud service or as a hosted service.

The server-side application has authentication and authorization framework for field user access to the application (user name/password, using Google/Facebook accounts, fingerprint scanning, retina scanning or other remote-id mechanisms). The application allows for differeing service levels of authorization, selective access to selective sections for the data and application.

The server side application performs many functions that are described below, but is not limited to just these functions. While the general sense of the “server” refers to a remote server, in specific situations, the server can be a localized server and physically attached to the device/instrument that runs the application.

The server shall remotely transfer pre-set data for the site, pre-set or configured instrument settings and system site-specific information (such as access information) into the application. Such pre-set data may be entered into the server-side application through manual or automated means.

The server shall render the collected data from the field application in a user readable form such as HTML based web pages.

The server shall provide the user the ability to customize the application for user and product specific needs which can then generate the application and server side components.

The server shall provide an interface mechanism for other web based applications through open APIs and services.

The server shall assist in managing the application data such as database storage, upload, download and synchronization of application data from application on the device to the server and backup of application data.

The server shall provide interfaces to customize user and product specific data validation and provide validation reports. For example, the server side application can be used to verify that a certain parameter that was collected is within the bounds of some preset limits at the server side.

The server shall provide a secure mechanism to transfer data between the field application and the server side application and server side databases.

The server shall be able to provide a portal for each vendor and for each product. The server shall also provide a unified portal across multiple vendors and multiple products.

The server-side application may incorporate other services and applications for voice-transcription, handwriting recognition of handwritten data from images, Optical Character Recognition (OCR) from images, image/feature recognition of specific features.

The server-side application shall provide business analytics based on the data.

The server-side application shall run Big-Data collection and analysis.

The server-side application can provide system-site specific action-recommendations to the user during any stage of the system install site or regarding any component of the system.

The server-side application provides various user (administrator, user, construction manager) privileges and modes (construction, maintenance, datafill) of operation.

The server-side application shall be used to authenticate devices and users and control the service level in terms of data access limitations. For example, a certain device is authenticated to access only certain data elements within the database tables.

The server-side application shall maintain an audit trail of the parameters that are collected. The audit-trail shall contain data such as data before change, user that changed the data and geo-location of the data change. The audit-trail is generated automatically upon request based on the history of the data collected.

The server-side application shall provide the ability to import data from various sources such as files, APIs or instruments. Such data may be used to set the parameters of a “sweep” process, limit checks and data analysis.

The server-side application shall provide the ability to output the data in a format that allows manual or automatic use of this data in other 3^{rd} party tools, software or instruments.

### FIELD APPLICATION

The customized field-application can be used to organize data collection with automated validation before the field user leaves the premises. Access to various parts of the field-application are controlled based on user's permission and a mode of operation. The field-application stores the collected data in a secure manner locally and synchronizes the data with a server on demand or on a periodic basis.

The field application performs many functions that are described below, but is not limited to just these functions.

The field application shall guide the user to take photos and videos of the equipment, cables, environment, signs and notices. The field application shall provide interfaces to scan bar codes and Q-R codes. The field-application shall guide the user to use voice recordings, to use the stylus pen for taking notes on a tablet. The field-application shall respond to gestures for certain actions. The field application shall also enable users to capture 360 degree view panoramic shots of certain features.

The field-application shall interface with an instrument (such as network and cable analyzers, PIM analyzers, OTDR, VIP analyzers, spectrum analyzers, oscilloscopes, GPS devices, survey devices) using a wired (such as USB/Ethernet) or a wireless link (such as WiFi/Bluetooth). The field-application shall also choose to download the instrument settings from the server-side application.

The field-application shall also interface with an accessory such as Google Glass or other external video and audio devices over a wired or a wireless link. The field-application shall operate in a mode wherein the video/audio can be simultaneously recorded while the user is collecting data into the field-application.

The field-application shall use the available sensors such as cameras, microphones, accelerometers, gyroscopes, pressure sensors, finger print sensors, light sensors, temperature sensors etc and use and record data from these sensors in the application.

The application shall use built-in location sensors (such as GPS, wifi) to identify and/or validate the location of each measurement/equipment—such as site, equipment, antenna etc.

The field-application shall also integrate a remote session capability through application programs such as WebEx, GotoMeeting, Skype, Facetime to stream the events from the site as they happen.

The field-application shall also have the ability to interface and exchange tasks and checks with other third party tools such as Siterra.

The field-application shall be able to synchronize, upload and download data to a remote server or device through a wired or wireless link on a periodic basis or when commanded by the user.

The field-application provides various user (administrator, user, construction manager) privileges and modes (construction, maintenance, datafill) of operation.

The field-application may incorporate other services and applications for voice-transcription, handwriting recognition of handwritten data from images, Optical Character Recognition (OCR) from images, bar code/QR code scanning, image/feature recognition of specific features. The field-application shall use the device's built-in features such as voice recognition and transcription, text-to-speech, handwriting recognition, keyboards and gestures.

The field-application shall record the time spent on each task or sub-task into its database.

The field-application shall be presented in a chosen user's language (such as English, Spanish). The language translation shall be either pre-set or use a translation service that provides context-sensitive translation.

The field-application shall also provide the ability to have video and audio instructions at every step of each of the tasks/processes. Such instruction shall be context sensitive and provide relevant information. The instruction shall also be in a language based on user's choice. This information can also be downloaded from the server side; each form field may be associated with a specific instruction.

The field-application shall operate such that various users using various devices can collect the data, but all of the data will be synchronized and resolved at a server.

The field-application shall interface with various hardware interfaces such as USB, Ethernet, WiFI, Bluetooth, Zigbee, InfraRed, NFC, Flutter and collects data from all equipment with such interfaces or equipment bridged with such interfaces (such as GPIB to USB).

The field-application shall also provide data validation and feedback to the user when the data is collected.

The field-application displays to the user if a certain process is complete (with the completion criterion defined by the user of the said application) and displays that process in a different way compared to a process that is incomplete.

The field application can connect to a remote center for video or audio interaction using custom or 3^{rd} party tools such as Skype/GoToMeeting/WebEx.

The field application shall geocode each of the entries/parameters as they are being collected and an audit trail of the changes will be maintained; The audit-trail shall contain data such as data before change, user that changed the data and geo-location of the data change. The audit-trail may also be stored locally.

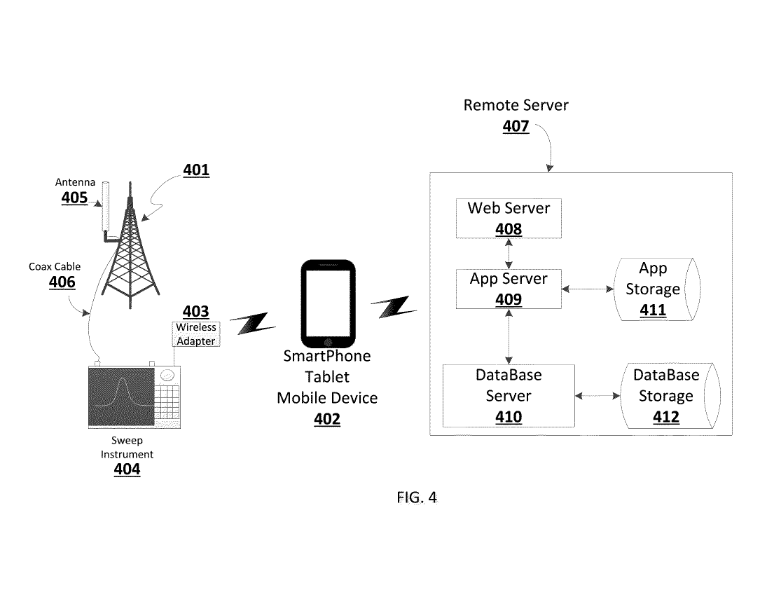

The framework for performing sweep measurements is illustrated in FIG. 4. In this setup the sweep measurements are performed using a personal computing device, such as a tablet PC or a smartphone (herein referred to as a tablet) 402, to setup and perform the measurements on the aforementioned instruments or any other instruments, 404. The collected data is then uploaded to the server-side application at the remote server 407 for further analyses and presentation of the data. Some analysis may also be performed on the personal computing collection device.

The server side application is also used to control the instrument settings, allowed equipment types and the steps involved in performing the measurements. For example, for a cable insertion loss measurement, the start and stop frequency of the sweep measurement for a specific cable sweep is setup through a web-interface on the server side. The field-application then synchronizes this setting and applies it to setup the instrument when performing a measurement for that system-component.

The tablet device communicates with the instrument in one of many ways: If the instrument has an Ethernet port, an Ethernet to Wireless bridge device 403 is used and the tablet communicates over a wireless link using the appropriate protocol (for example, Bluetooth, WiFi, Zigbee). If the instrument has a USB port, a tablet that can support USB host mode and has the ability to load a custom software to communicate with the instrument, can communicate over the USB link. A USB to wireless bridge may also be used in some cases. Most tablets have USB host mode support, but is a challenge to load a custom driver to communicate with the instrument without having to root the tablet device. In such cases a simple electronic circuit board that has the hardware and software to translate the instrument's access port (such as USB) to a driver-agnostic interface such as Ethernet or WiFi can be used. This is also applicable for cases where the tablet does not have USB host mode support. If the instrument supports a serial RS232 port, an adapter that converts RS232 to USB can also be used.

This invention is useful for the following type of measurements but not limited to. automation of cable loss analysis, insertion loss analysis, return loss analysis, distance-to-fault measurement, cable length measurement, cable delay measurement, passive inter-modulation (PIM) analysis, and antenna quality measurement.

Specific use cases of the tablet device 402 to communicate with the test instrument is described below but not limited to the listed functions. The tablet can be used to measure various parameters of an antenna 405 or a coaxial or a fiber cable 406. The framework can be used in a tower setting 401 or in a rooftop or inside a building as the need may be.

The tablet shall provide the ability to import or exports the data in a format that allows manual or automatic use of this data in other 3^{rd} party tools, software or instruments.

The tablet device also provides the ability control not only measurement but other instruments that may be used for site data collection.

The tablet is used to setup the instrument settings for a specific operation such as setting up the start and stop frequencies, limit lines, propagation velocity factors, cable types, markers etc. The tablet is used to store and retrieve traces from the instrument in the form of one or many of raw trace data and image files. The table is used to command the instrument to perform various operations such as setting up the modes of operation, storing trace data on memory or disk for retrieval by the tablet or other external equipment (like a PC) for use later.

The tablet is used to set the file names of the traces, set marker names, display or hide markers, display or hide limit lines on the instrument.

The tablet is used to guide the user through the calibration process for the instrument.
The tablet is used to guide the user through the measurement process in a step by process, indicating along the way what elements under measurements need to be connected to the instrument.

Server side application is used to customize all of the above functions, settings, configurations. An interface on the server side is used to allow the end user to view the results of the functions and customize the function to get the best outcome. It will prevent expensive site revisit and measurements.

The server side application will also provide an interactive detailed view of the traces and results collected and provide the user with an interface for an approval workflow. The user will be able to choose the reports that the user desires and generate a comprehensive report in electronic form (such as Portable Document Format—PDF).

The tablet has rich HTML,audio,video instructions on how to perform the measurements.

The tablet is used to communicate the results of the sweeps to the end user through electronic mail or push notifications or sms and upload the sweep results to the web-service and provide a hyperlink to the end user for review. The tablet can also email the results, produce a summary report and store it in local storage.

The tablet is used to provide feedback to the user based on the collected data about the validity of the data—such as asking the user to verify the cable connections or terminations when the measured data indicates improper quality.

The tablet retrieves data that was collected at an earlier time for a specific cable or antenna to compare against data being collected currently. This is very useful during maintenance scenarios to verify if a cable or antenna has deteriorated in performance.

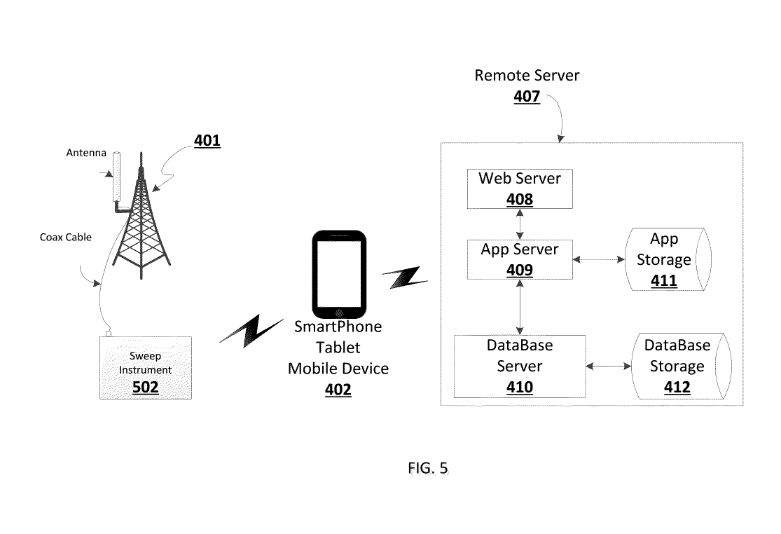

In another embodiment for the sweep measurement framework illustrated in FIG. 5., an electronic device 502 that performs the sweep measurement has connectivity to a tablet computer through either a wireless (WiFi, Bluetooth, Zigbee) or a wired link (USB). The tablet computer 402 controls the sweep instrument, retrieves the data from the instrument and performs further analysis. The obviates the need for having an instrument with a built-in display and allows full flexibility and capability of the tablet computer as technology evolves. This helps reduce the weight of the instrument, improves battery life and the greatly reduces the cost of the instrument.

I claim:

1. A system, comprising:
a mobile device, having a processor, a memory, at least one sensor;
a remote server, having a web server operatively coupled to an application server, wherein the application server is operatively coupled to an application storage, and;
a database server, in communication with the application server, wherein the database server comprises a database storage.

2. A system, comprising:
a mobile device, comprising:
a mobile application operatively coupled to a database storage, wherein the mobile application is in communication with a mobile device synchronization service;
a remote server, comprising:
a web service, operatively coupled to a web application, wherein the web application is operatively coupled to a server storage in communication with a remote server synchronization service, wherein the remote server synchronization service is in communication with the mobile device synchronization service, and;
an authentication service, operationally coupled to the web service, further operationally coupled to the mobile device synchronization service, further operatively coupled to the mobile application.

3. A system, comprising:
an application framework generator;
a mobile application, operatively coupled to the application framework generator, and;
a web application, operatively coupled to the application framework generator.

4. The system of claim 1, further comprising a wireless adapter in communication with the mobile device;
a measurement instrument, operatively coupled to the wireless adapter;
a cable, in communication with the measurement instrument, wherein the cable is operatively coupled to an antenna.

5. The system of claim 1, further comprising a measurement instrument in communication with the mobile device, wherein the measurement instrument is operatively coupled to a cable, wherein the cable is in communication with an antenna.

6. The system of claim 2, wherein the authentication service is configured to allow only authorized service users to access to the system.

7. The system of claim 2, wherein the synchronization service is adapted to keep a quantity of data identical between the mobile device and the remote server.

8. The system of claim 2, wherein the web application is adapted to generate reports.

9. The system of claim 2, wherein the web application is adapted to download a quantity of collected data.

10. The system of claim 1, wherein the mobile device further comprises a field application, adapted to collect and store a quantity of data.

11. The system of claim 2, wherein the mobile device further comprises a field application, adapted to collect and store a quantity of data.

12. The system of claim 10, wherein the field application is adapted to guide a user to perform one or more of the functions, consisting of: scan bar codes, scan Q-R codes, use voice recordings, or use a stylus pen.

13. The system of claim 11, wherein the field application is adapted to guide a user to perform one or more of the functions, consisting of: scan bar codes, scan Q-R codes, use voice recordings, or use a stylus pen.

14. The system of claim 12, wherein the field application is adapted to interface with one or more of the following instruments, consisting of: a network analyzer, a cable analyzer, a spectrum analyzer, an oscilloscope, a GPS device, or a survey device.

15. The system of claim 13, wherein the field application is adapted to interface with one or more of the following instruments, consisting of: a network analyzer, a cable analyzer, a spectrum analyzer, an oscilloscope, a GPS device, or a survey device.

16. The system of claim 14, wherein the field application is adapted to use one or more of the following sensors, consisting of: a camera, a microphone, an accelerometer, a gyroscope, a pressure sensor, a fingerprint sensor, a light sensor, or a temperature sensor.

17. The system of claim 15, wherein the field application is adapted to use one or more of the following sensors, consisting of: a camera, a microphone, an accelerometer, a gyroscope, a pressure sensor, a fingerprint sensor, a light sensor, or a temperature sensor.

18. The system of claim 1, adapted to measure one or more of the following, consisting of: a cable loss, an insertion loss, a return loss, a distance to fault measurement, a cable length measurement, a cable delay measurement, a passive intermodulation analysis, or an antenna quality measurement.

19. The system of claim 2, adapted to measure one or more of the following, consisting of: a cable loss, an insertion loss, a return loss, a distance to fault measurement, a cable length measurement, a cable delay measurement, a passive intermodulation analysis, or an antenna quality measurement.

20. The system of claim 3, adapted to measure one or more of the following, consisting of: a cable loss, an insertion loss, a return loss, a distance to fault measurement, a cable length measurement, a cable delay measurement, a passive intermodulation analysis, or an antenna quality measurement.
